(19) United States
(12) Patent Application Publication
(10) Pub. No.: US 2012/0149447 A1
(43) Pub. Date: Jun. 14, 2012

(54) SLIDING TYPE PORTABLE TERMINAL

(75) Inventors: Ki-Bok SON, Gyeongsangbuk-do (KR); Chang-Won HUR, Busan (KR)

(73) Assignee: SAMSUNG ELECTRONICS CO., LTD., Gyeonggi-Do (KR)

(21) Appl. No.: 13/185,911

(22) Filed: Jul. 19, 2011

(30) Foreign Application Priority Data
Dec. 9, 2010 (KR) 10-2010-0125237

(51) Int. Cl. H04W 88/02

(52) U.S. Cl. 455/575.4

(57) ABSTRACT

A sliding type portable terminal includes: a first housing; a second housing coupled with the first housing in a state in which the second housing is slidable in one direction while facing the first housing; a guide member mounted on one surface of the first housing; and guide ribs provided at the guide member and slidably coupled with one surface of the second housing, wherein an opening is formed through each of the guide ribs, and the guide member extends along a direction in which the second housing slides. The sliding type portable terminal can achieve a smooth sliding operation of one housing against the other and provide a durable coupling between the guide member and the second housing by reducing a frictional area in a sliding operation between the housings through formation of the opening at the guide rib.

### CLAIM OF PRIORITY

This application claims the priority under 35 U.S.C. §119 of an application entitled “Sliding Type Portable Terminal” filed in the Korean Intellectual Property Office on Dec. 9, 2010 and assigned Serial No. 10-2010-0125237, the contents of which are hereby incorporated by reference.

### BACKGROUND OF THE INVENTION

1. Field of the Invention

The present invention relates to a portable terminal, and more particularly to a sliding type portable terminal including a pair of housings facing each other so that one housing can slide with respect to the other housing.

2. Description of the Related Art

In general, a portable terminal is classified into a bar-type, a flip-type, a folder-type, and a sliding type terminal.

A bar-type terminal corresponds to a type in which a data input/output means, a microphone part and a speaker part are mounted within single body housing. An earlier bar-type terminal had drawbacks in that a keypad for data input is always exposed to the outside causing a malfunction due to impact. The design also impose a limitation in miniaturization due to a problem of providing a distance between the microphone part and the speaker part. However, recently, as a multimedia function such as reproduction of videos or the like is becoming popular, a bar-type portable terminal provided with an input/output device through a touch screen has become widely used.

A flip-type terminal corresponds to a type including a body, a flip, and a hinge module to connect the body with the flip. The body is provided with a data input/output means, a microphone part and a speaker part. Although the flip covers a keypad of a data input means to prevent its malfunction, the flip-type terminal also has a limitation in miniaturizing its size as it requires to provide a distance between the microphone part and the speaker part.

A folder-type terminal corresponds to a type including a body, a folder, and a hinge module to rotatably connect the body with the folder, in which the folder is pivoted to be opened and closed. The folder-type terminal is advantageous in its miniaturization in which malfunction of the keypad can be prevented in a call-waiting mode where the folder is closely in contact with the body, while the folder is opened to provide a sufficient distance between the microphone part and the speaker part in a call mode.

Meanwhile, as designs of the portable terminal become diversified, a sliding type terminal is gradually commercialized in which two housings are provided and one housing slides on the other housing for opening/closing the latter. The housings of the sliding type terminal have constructions to be slidably displaceable in a lengthwise, i.e., longitudinal direction, while there is also a terminal capable of being slidable in a transverse direction.

The sliding type terminals as such essentially require a slide module to couple a pair of housings in a slidable state. Among others, it is necessary to provide a guide member which is mounted on a first housing and slidably coupled with a second housing.

Such a slide module, and in more detail, the guide member must allow the sliding of the second housing to be smooth with respect to the first housing and maintain a coupled state of the first and second housings in a stable manner. To make a smooth sliding of the second housing, it is desirable to loosely couple the guide member with the second housing. In other words, there should be a gap in a certain degree at engaging portions between the guide member and the second housing. However, such a gap may cause the second housing to move in a different direction from its original direction, which makes it difficult to stably maintain the coupled state of the first and second housings.

In addition, the slide module is generally manufactured using mainly a metallic material in order to stabilize and reinforce the coupled state of the first and second housings. However, in the case that the guide member or the like is permanently deformed due to external impacts, it has drawbacks in that the sliding is not smoothly made or even impossible.

### SUMMARY OF THE MENTION

Accordingly, the present invention has been made to solve the above-mentioned problems occurring in the prior art, and an aspect of the present invention provides a sliding type portable terminal which can prevent unnecessary movement of housings by coupling the housings in a stable manner.

Also, another aspect of the present invention provides a sliding type portable terminal capable of stably maintaining the coupled state between the housings, while allowing a smooth sliding therebetween.

Still another aspect of the present invention provides a sliding type portable terminal which can alleviate the deformation of components even when external impacts or the like are applied thereto.

In accordance with an aspect of the present invention, a sliding type portable terminal includes: a first housing; a second housing coupled to the first housing in a state in which the second housing is slidable in one direction while facing the first housing; a guide member mounted on one surface of the first housing; guide ribs provided at the guide member and slidably coupled with one surface of the second housing; and an opening formed through each of the guide ribs, wherein the guide member extends along a direction in which the second housing slides.

Preferably, the opening is formed at the center portion of the guide member, and it is desirable that the guide ribs are provided at both side ends of the guide member, respectively.

Further, it is preferred that the terminal further includes slits formed at the rear surface of the second housing, wherein the portion of the guide ribs are disposed within the second housing through the slits, and the opening is formed at a portion of each of the guide ribs disposed within the second housing. In addition, the terminal may further include an elastic member, which has one end supported by the second housing and an opposite end supported by the guide member, wherein the elastic member applies an elastic force exerting in a direction to space said one end and said opposite end away from each other.

It should be appreciated that the sliding type portable terminal as constructed above can reduce a frictional area in a sliding operation between the housings by forming the opening at the guide rib, thus achieving a smooth sliding operation of one housing against the other. Furthermore, compared with a conventional sliding type portable terminal without an opening at a guide rib, it is possible to provide a durable coupling between the guide member and the second housing. In other words, as the friction area in the sliding operation is reduced with the aid of opening, it is possible to accomplish a closer coupling between the guide member and the second housing, while maintaining a smooth sliding operation therebetween.

Further, it is possible to prevent unnecessary movement of the second housing as the opening formed at the guide rib acts as a buffer space which allows the second housing to be deformed in a certain degree when an external force within a permissible range is applied to the second housing, thus makes it possible to prevent the guide member or the like from permanently being deformed. That is, deformations of the second housing due to an external force within a permissible range can be restored to its initial shape by coupling structures between the components constituting the second housing and the restoration force of the same. Accordingly, without using a metallic material, it is possible to construct a slide module of a high rigidity synthetic resin.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view illustrating a sliding type portable terminal in accordance with an exemplary embodiment of the present invention;

FIG. 2 is a perspective view illustrating a state wherein a second housing of the sliding type portable terminal shown in FIG. 1 has slid;

FIG. 3 is a perspective view illustrating a state wherein a guide member is coupled with the second housing shown in FIG. 1;

FIG. 4 is a perspective view illustrating a state wherein the second housing shown in FIG. 3 has slid with respect to the guide member;

FIG. 5 is a perspective view illustrating the guide member shown in FIG. 3; and

FIG. 6 is a plan view illustrating an inner surface of the second housing shown in FIG. 3.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention rather unclear.

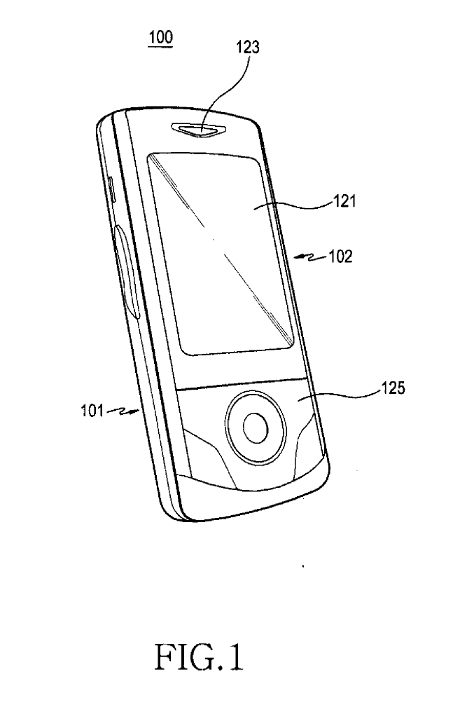

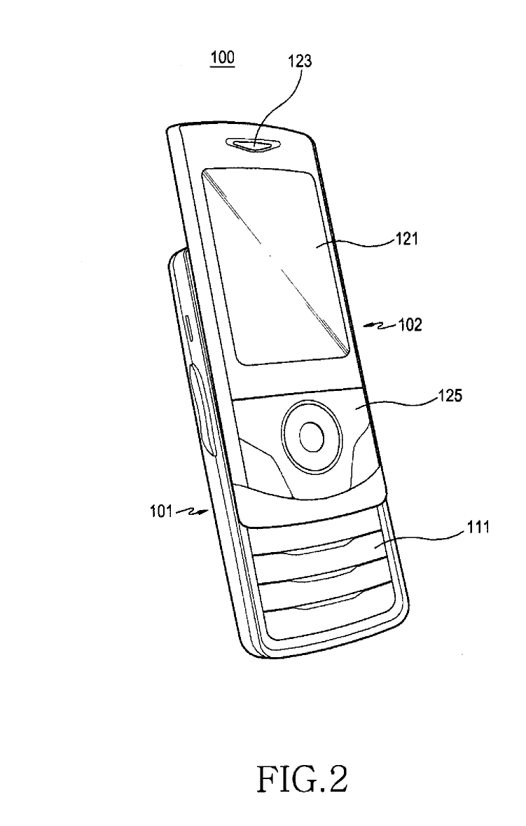

Referring to FIGS. 1 and 2, a sliding type portable terminal 100 in accordance with an exemplary embodiment of the present invention includes a first housing 101, and a second housing 102, which is slidably coupled with the first housing 101 while facing the first housing 101.

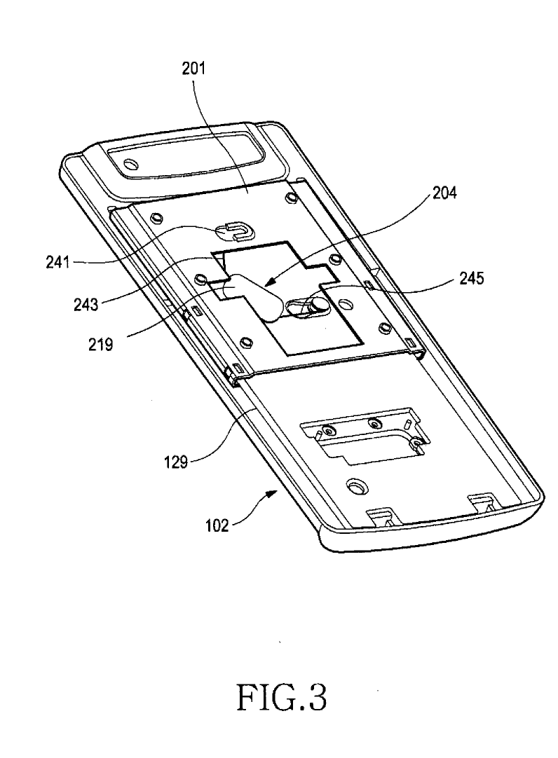

The first housing 101 is provided with a keypad 111 installed on one surface thereof, and the keypad 111 is selectively opened and closed through a sliding of the second housing 102. A guide member 201 (see FIG. 3) is slidably mounted over the keypad 111 area in the first housing 101. The guide member 201 is designed to couple the second housing 102 to the first housing 101, guiding the sliding movement of the second housing 102. The area in which the guide member 201 is installed is always hidden regardless of the sliding action of the second housing 102. In other words, the guide member 201 is not exposed to the outside even after the second housing 102 slides.

The second housing 102, as previously mentioned, is sildably coupled to the first housing 101 through the guide member 201. A display device 121 is installed on the front surface of the second housing 102. A speaker part 123 is disposed above the display device 121, and a second keypad 125 is provided below the display device 121. The keypad 111 installed in the first housing 101 is used for mainly inputting numerals and characters, while the second keypad 125 includes keys to activate calling functions, searching and browsing a menu, initiating and completing a voice communication, messaging, or taking pictures, etc.

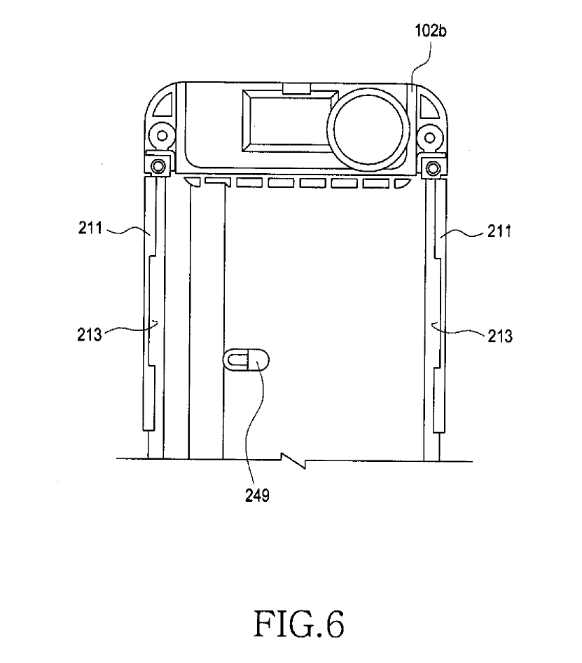

Hereinafter, the guide member 201 and its installation structure will be described in more detail with reference to FIGS. 3 to 6.

The guide member 201 is slidably mounted on one surface of the first housing 101. The guide member 201 includes guide ribs 211 provided at opposite lateral ends thereof, respectively. The guide ribs 211 are formed by bending the opposite ends of the guide member 201 in an inward direction. Hence, the guide member 201 has generally a U-shaped cross-section, and the bent portion may be formed in a curved or angled shape. The guide member 201 is formed with an wire hole 215 for wiring at the center portion thereof. A flexible printed circuit board (not shown) extends from the inside of the first housing 101, protrudes out of the first housing 101 through the wire hole 215, and enters into the second housing 102.

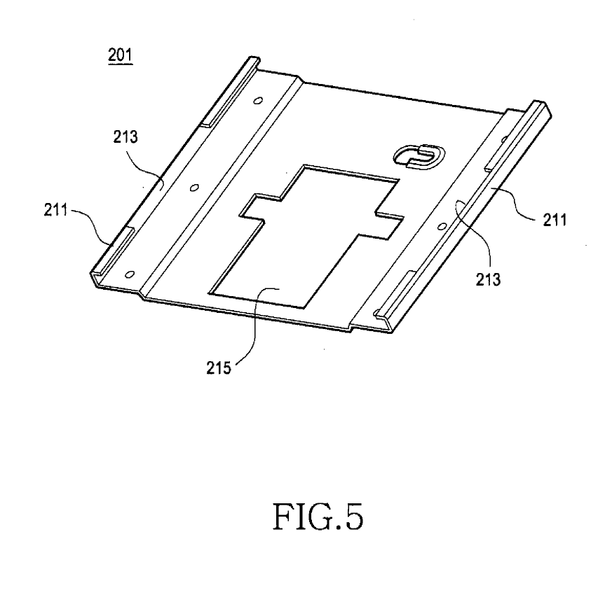

The guide member 201 extends along the sliding direction of the second housing 102 with an opening 213 (see FIG. 5) formed at its center portion. The guide member 201 is engaged with the first housing 101. The second housing 102 is slidably coupled with the first housing 101. That is, the second housing 102 is joined with the first housing 101 through the guide member 201, more specifically through the guide ribs 211, and thus can slide by guidance of the guide rib 211.

For the engagement with the guide ribs 211, the second housing 102 may have slits 129 formed on its other surface, i.e., on its rear surface. The slits 129 extend along the sliding direction of the second housing 102, and are formed in pairs adjacent to the opposite lateral ends of the second housing 102. Hence, a portion of the guide member 201 is positioned inside the second housing 102 through the slits 129. The opening 213 is also located within the second housing 102. As such, the guide member 201 is positioned outside the second housing 102 and sildably coupled to the second housing 102.

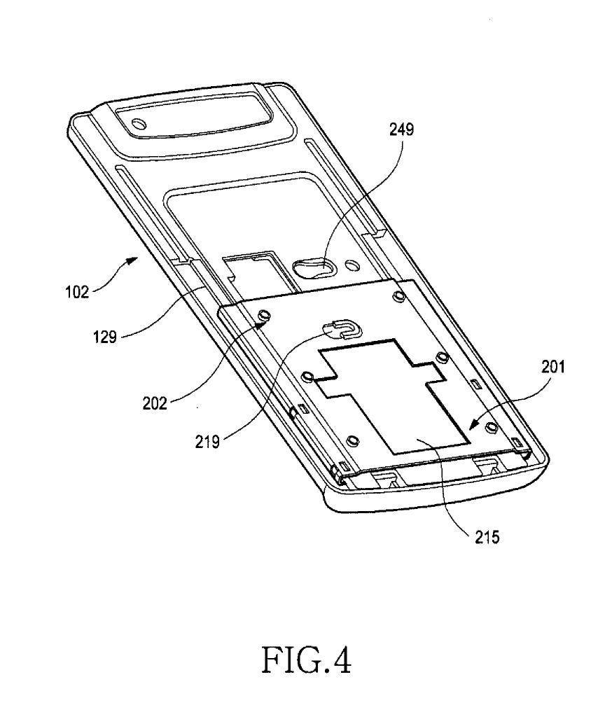

Referring to FIGS. 3 and 4, in a state wherein the guide member 201 is coupled to the rear surface of the second housing 102, the second housing 102 is disposed in front of the first housing 101 and a screw (not shown) is fastened from the inside of the first housing 101. The screw penetrates through the first housing 101 to be fastened with the guide member 201, so as to secure the guide member 201 to the first housing 101.

Meanwhile, the terminal 100 is provided with an elastic member 204 to apply a driving force when sliding the second housing 102. One end 243 of the elastic member 204 is supported at the guide member 201, while the other end 245 is supported at the rear surface of the second housing 102. The elastic member 204 is formed with an elastic portion 241 between the opposite ends 243 and 245. The elastic portion 241 is provided with a coil spring (not shown) therein, which exerts an elastic force in a direction to space the opposite ends 243 and 245 supported at the guide member 201 and the second housing 102 away from each other.

In the present embodiment, the elastic member 204 has an elastic portion 241 including a coil spring and opposite ends 243 and 245, to which the elastic portion 241 applies an the elastic force in a direction to space them away from each other. However, it should be noted that the present invention can be applied to any type of elastic member capable of applying an the elastic force in a direction to space the opposite ends away from each other.

When the elastic member 204 is disposed in the terminal 100, a point (referred to as a ‘neutral point’ hereinafter) where the opposite ends 243 and 245 of the elastic member 204 become closest to each other is included within the sliding range of the second housing 102. Hence, in a range from the neutral point to a point where the keypad 111 is closed, a driving force exerted in a direction to close the keypad 111 is applied to the second housing 102. In contrast, in a range from the neutral point to a point where the keypad 111 is fully opened, a driving force exerted in a direction to open the keypad 111 is applied to the second housing 102. Accordingly, when a user wants to open or close the keypad 111, once the user has moved the second housing 102 to a location just past the neutral point, the elastic force of the elastic member 204 thereafter moves the second housing 102 in the remaining range.

While the invention has been shown and described with reference to certain exemplary embodiments thereof, it will be understood by those skilled in the art that various changes in form and details may be made therein without departing from the spirit and scope of the invention as defined by the appended claims.

For instance, although a guide member is directly coupled to the rear surface of a second housing in the embodiment of the present invention described above, a separate slide member may be slidably coupled to the guide member and installed on the rear surface of the second housing. In this case, the slit is not indispensable and a guide rib may be coupled in a construction to enclose the opposite lateral ends of a slide member.

What is claimed is:

1. A sliding type portable terminal, comprising:
a first housing;
a second housing slidably coupled to the first housing; and
a guide member having a pair of guide ribs mounted at one surface of the first housing, the guide ribs each having an opening thereof slidably coupled to one surface of the second housing,
wherein the guide member extends along a direction in which the second housing slides.

2. The sliding type portable terminal as recited in claim 1, wherein the opening is formed at a center portion of each of the guide ribs.

3. The sliding type portable terminal as recited in claim 1, wherein the guide ribs are provided at both side ends of the guide member, respectively.

4. The sliding type portable terminal as recited in claim I, further comprising slits formed at the rear surface of the second housing, wherein a portion of the guide ribs are disposed within the second housing through the slits.

5. The sliding type portable terminal as recited in claim 4, wherein the opening is formed at the portion of each of the guide ribs disposed within the second housing.

6. The sliding type portable terminal as recited in claim I, further comprising an elastic member, which has one end supported by the second housing and an opposite end supported by the guide member, wherein the elastic member applies an elastic force exerting in a direction to space said one end and said opposite end away from each other.

7. The sliding type portable terminal as recited in claim 1, wherein the opening of the guide ribs serves to prevent deformations of the second housing due to an external force.

8. The sliding type portable terminal as recited in claim 1, wherein the guide member comprises an wire opening at the center portion thereof for wiring.

9. The sliding type portable terminal as recited in claim 1, wherein the opening of the guide ribs serves to reduce a friction area during a sliding operation between the guide member and the second housing.
